(19) United States
(12) Patent Application Publication
(10) Pub. No.: US 2006/0268418 A1
(43) Pub. Date: Nov. 30, 2006

(54) Optical films, method of making and method of using

(76) Inventor: Jong M. Kim, Manalapan, NJ (US)

Correspondence Address: RONALD D. TRICE, 6412 BRANDON AVE., # 145, SPRINGFIELD, VA, 22150, US

(21) Appl. No.: 11/417,132

(22) Filed: May 4, 2006

Related U.S. Application Data
(60) Provisional application No. 60/677,837, filed on May 5, 2005.

(51) Int. Cl. G02B 27/10

(52) U.S. Cl. 359/618

(57) ABSTRACT

An optical film including a plurality of structures formed from a material with each structure having a base, a first side wall that forms an acute angle with the base, and a second side wall that forms an obtuse angle with the base. The optical film efficiently couples light out of a light source or other structure. The optical film may be fabricated with a photolithographic process.

### RELATED APPLICATIONS

This application claims priority from, and incorporates by reference, U.S. Provisional Application Ser. No. 60/677,837, filed May 5, 2005.

### FIELD OF THE INVENTION

The present invention relates generally to optical films, methods of making optical films, and methods of using optical films, and more particularly, slanted waveguide optical films, methods of making slanted waveguide optical films, and methods of using slanted waveguide optical films.

### BACKGROUND

It is desirable for displays including backlights with edge-lit illuminators to have low power consumption, high brightness, high light utilization efficiency, good light uniformity, low profile, low weight, minimal color effects and low cost. However, this is difficult to achieve because there are typically tradeoffs between power consumption, brightness, light utilization efficiency, light uniformity, profile, weight, color effects and cost. For example, a higher output intensity light source increases the brightness but also increases power consumption. Accordingly, there is a strong need in the art to improve power consumption, brightness, light utilization efficiency, light uniformity, profile, weight, color effects and cost in displays including backlights with edge-lit illuminators.

### SUMMARY OF THE INVENTION

An aspect of the present invention is to provide an optical film including a plurality of structures formed from a material with each structure including: a base, a first side wall that forms an acute angle with the base, and a second side wall that forms an obtuse angle with the base. The optical film may further include a substrate having a top surface, wherein the plurality of structures are on or adjacent the top surface. The acute angle may be equal to about (90+δ)/2, where δ is the angle of light coming into the plurality of structures. The parameter h may be equal to about a tan δ tan θ (tan θ−tan δ), where h is the height of the structures, a is the width of the base of each structure, δ is the angle of light coming into the plurality of structures, and θ is the acute angle. Each structure may include a top such that the first side, the second side, the base and the top form a quadrilateral. The top may be flat or textured. The material may be a photopolymerized material. Another material may be between adjacent structures of the plurality of structures and may have a lower refractive index than the material of the plurality of structures. The another material may include scattering particles. The another material may be air. The optical film may further include a diffusing material that covers the another material and a surface of each structure opposite the base. Each first side wall may be coated with a reflective coating. The reflective coating may be a metal coating or a dielectric material coating. The another material may be between adjacent structures of the plurality of structures and may cover a surface of each structure opposite the base.

Another aspect of the present invention is to provide an optical film including a substrate, a plurality of structures on or adjacent the substrate and formed from a photopolymerized material with each structure including: a base, a first side wall that forms an acute angle with the base, a second side wall that forms an obtuse angle with the base, and a top. The top being substantially parallel to the base, forming an acute angle with the second side wall, and forming an obtuse angle with the first side wall, and another material having a lower refractive index than the material of the plurality of quadrilateral structures, the another material being located between adjacent first and second side walls. The another material may cover the tops of the plurality of structures.

Another aspect of the present invention is to provide a method of making an optical film including depositing a photopolymerizable material on a surface, selectively polymerizing part of the photopolymerizable material such that a plurality of polymerized structures is formed in the photopolymerizable material, each polymerized structure having: a first side wall that forms an acute angle with the surface, and a second side wall that forms an obtuse angle with the surface, and removing the photopolymerizable material not polymerized. The selectively polymerizing may be performed by illuminating a photomask with collimated light that is incident on the surface at a non-normal angle. The method may further include depositing an optically clear filler material between the plurality of polymerized structures subsequent to the step of removing the photopolymerizable material not polymerized.

Another aspect of the present invention is to provide an optical film for use in a light source including a substrate and a plurality of structures formed from a photopolymerized material with each structure including: a base, a first side wall that forms an acute angle with the base, and a second side wall that forms an obtuse angle with the base. The h is equal to about a tan δ tan θ (tan θ−tan δ), where h is a height of the structures, a is a width of the base of each structure, δ is an angle of light coming into the plurality of structures from a light source, and θ is the acute angle.

### BRIEF DESCRIPTIONS OF THE DRAWINGS

The invention will be described in detail with reference to the following drawings in which like reference numerals refer to like elements wherein:

FIG. 1 illustrates light rays from a light source passing through an optical film according to the present invention;

FIG. 2 illustrates the completed optical film after a tenth and eleventh step of manufacture are completed;

FIG. 3 illustrates the optical film after a first step of manufacture is completed;

FIG. 4 illustrates the optical film after a second step of manufacture is completed;

FIG. 5 illustrates the optical film after a third step of manufacture is completed;

FIG. 6 illustrates the optical film after a fourth step of manufacture is completed;

FIG. 7 illustrates the optical film after a fifth step of manufacture is completed;

FIG. 8 illustrates the optical film after a sixth step of manufacture is completed;

FIG. 9 illustrates the optical film after a seventh, eighth and ninth step of manufacture are completed;

FIG. 10 illustrates another optical film which similar to that of FIG. 2 but further including a diffuser medium;

FIG. 11 illustrates another optical film which similar to that of FIG. 2 but further including a reflective coating on one of the side wall surfaces of plurality of structures;

FIG. 12 illustrates an exemplary optical film with continuous structures;

FIG. 13 illustrates an exemplary optical film with segmented structures;

FIGS. 14, 15 and 16 illustrate various parameters of an optical film;

FIG. 17 is a black and while photograph of an optical film with a high aspect ratio;

FIG. 18 is a black and while photograph of an optical film with a low aspect ratio;

FIG. 19 illustrates a prior art back-illuminator or backlight for a transmission type LCD; and

FIG. 20 illustrates the performance of four backlight units.

### DETAILED DESCRIPTION

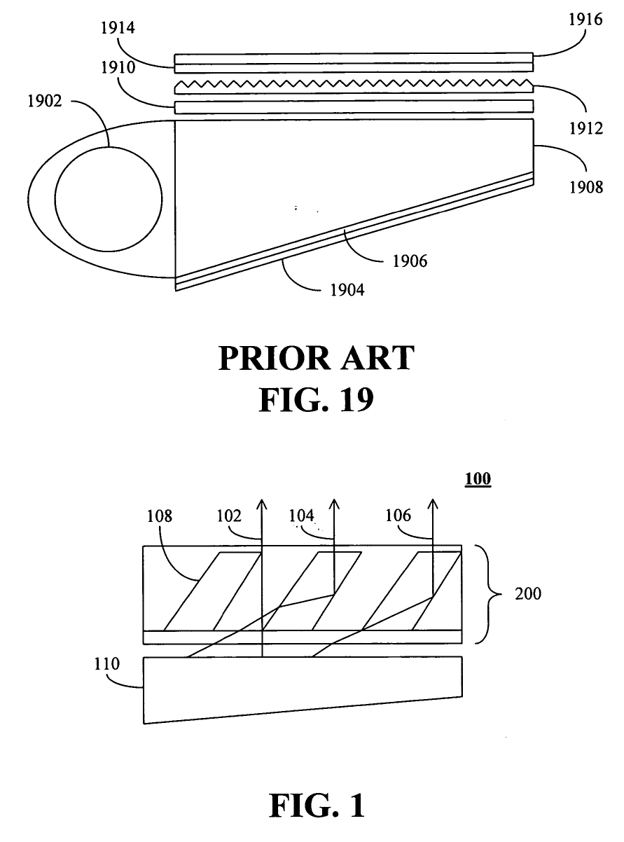

The present invention provides an optical film including a plurality of microstructures that couples and redirects light by transmitting and/or reflecting and/or refracting received light such that the received light is substantially redirected toward a desired output direction. This is partly illustrated in FIG. 1 where an optical film 200 receives three different light rays. The first ray 102 simply passes through the optical film 200 without refraction or reflection. The second ray 104 is refracted by a microstructure 108 of the optical film 200 and then undergoes total internal reflection within the same microstructure 108. The third ray 106 enters a microstructure 108 of the optical film 200 and then undergoes total internal reflection within the same microstructure 108. Each of these three rays 102, 104, 106 is output along the desired output direction. It is the ability of the optical film 200 to couple and redirect a substantial portion of the light received from a light source 110 toward the desired direction that makes this optical film 200 highly efficient. This is achieved, at least in part, by the optical film 200 being able to reflect some of the input light.

The efficiency and simple construction of the optical film 200 allows for reduced power consumption, which in turn allows for smaller batteries, reduced size and reduced weight which is advantageous with mobile applications and may provide other advantages depending upon the application. For example, the high light utilization efficiency of the optical film 200 increases the brightness and helps ensure viewable in daylight. The optical film 200 also may reduce the thickness, improve contrast ratio, improve uniformity, and improve color or grayscale representing capability for a desired application. The simple construction of the optical film 200 may reduce cost when the optical film 200 is substituted for a number of other conventional elements.

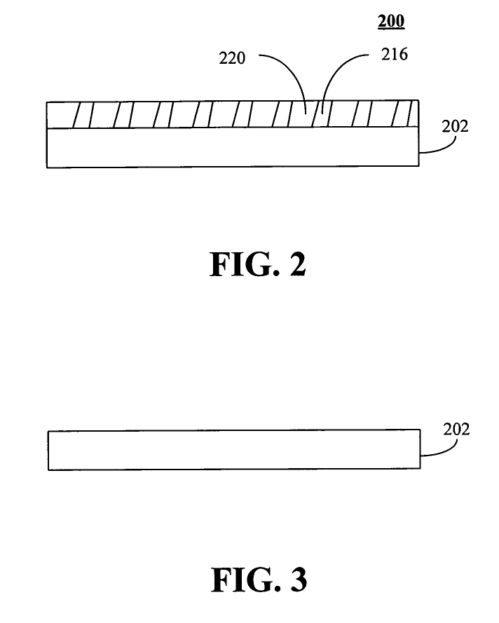

FIG. 2 illustrates an exemplary optical film 200 including a substrate 202, a plurality of structures 216 formed by polymerizing selected portions of a coating of photopolymer 204, and optically clear material 220 located between the plurality of structures 216. The optically clear material 220 may also be located above the plurality of structures 216 and may fully or partial fill the space between adjacent structures 216.

A photolithographic process including may be used to manufacture the optical film 200 of FIG. 2. For example, FIG. 3 illustrates the optical film 200 after a first step of manufacture is completed. In the first step, the substrate 202, which may be made from material that is substantially transparent to UV light, such PET PC, PVA, PMMA, MS or any other suitable material, and has a thickness of about 0.5 mils to about 8.0 mils with about 2.0 to about 3.0 mils being typical, is cleaned or otherwise prepared before use. In addition to being transparent to UV light, the substrate 202 should be optically transparent to the frequencies of light which the optical film 200 will be redirecting (e.g., visible light in the 300 to 800 nm range). Furthermore, it is advantageous that the substrate 202 be scratch free and has a low haze value.

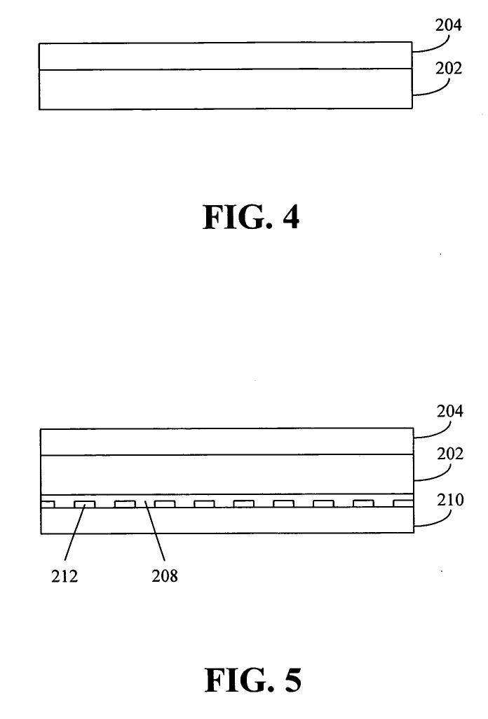

FIG. 4 illustrates the optical film 200 after a second step of manufacture is completed. In this step, a coating of photopolymer 204 is deposited on the substrate 202. The thickness of the coating of photopolymer 204 is selected so as to produce a polymerized structure of the desired height. Any suitable photopolymer may be used. For example, the photopolymer may be a monomer or mixture of various monomers, a photoinitator, an antioxidant and an adhesion promoter. The monomer or mixture of various monomers may be acrylates. For example, monomer based on diacrylate or triacrylate such as Startomer from Sartomer Corporation. The photoinitator may be any photoinitator. For example, Igacure from Ciba. The antioxidant helps prevent polymerization through an oxygen effect and may be any suitable antioxidant. For example, Iganox from Ciba. The adhesion promoter is used to promote the adhesion power between monomer and substrate may be any suitable adhesion promoter. For example, silane group or polyester acrylates based adhesion promoters. FIG. 5 illustrates the optical film 200 after a third step of manufacture is completed. In this step, the substrate 202 coated with the photopolymer 204 is placed onto a photomask 212 having a predefined design. The photomask 212 is on a substrate 210. An index matching fluid 208 may be placed between the substrate 202 and the photomask 212, between the substrate 202 and its substrate 210. The photomask 212 may be a Cr photomask, an emulsion photomask or any other suitable photomask. The index matching fluid 208 is selected to have a refractive index similar to the refractive index of the substrate 202 and may be IPA, EOH, MeOH, acetone or any other suitable material or materials.

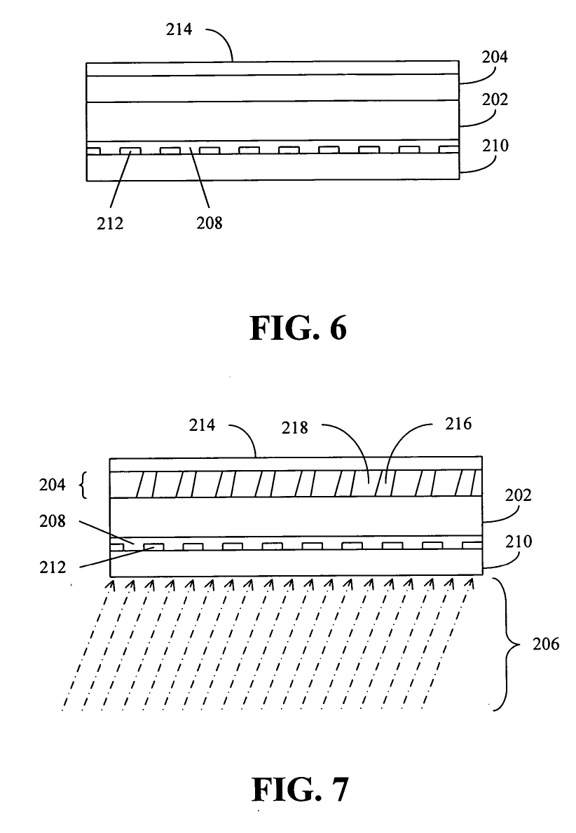

FIG. 6 illustrates the optical film 200 after a fourth step of manufacture is completed. In this step, an optically transparent cover film 214 is placed on the coating of photopolymer 204. The optically transparent cover film 214 acts as an oxygen barrier. The optically transparent cover film 214 may be made similar to substrate 202 except that its thickness may be made thinner (e.g., about 0.5 to about 2.0 mils thick).

FIG. 7 illustrates the optical film 200 after a fifth step of manufacture is completed. In this step, a collimated ultra violet light source produces light 206 with sufficient energy to form the desired plurality of structures 216. This light 206 is then projected onto the photomask 212 at a predetermined angle such that the areas of the coating of photopolymer 204 corresponding to gaps in the photomask 212 are polymerized to form the desired plurality of structures 216 while the remaining areas are left as unpolymerized photopolymer 218.

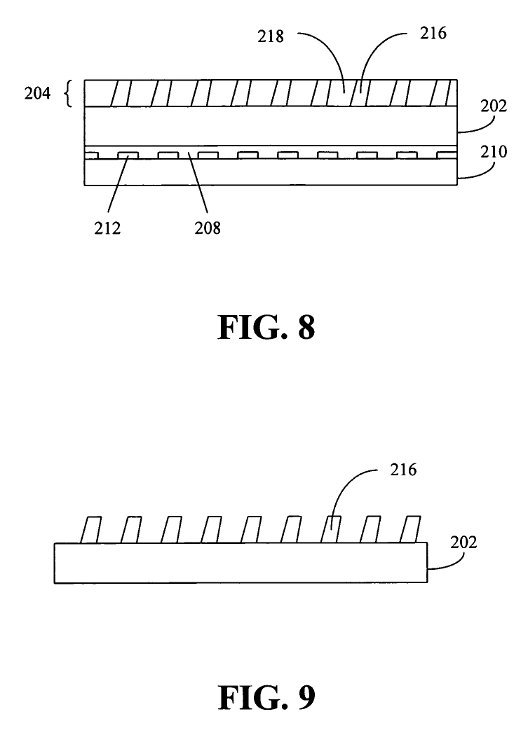

FIG. 8 illustrates the optical film 200 after a sixth step of manufacture is completed. In this step, the optically transparent cover film 214 is removed so that the developing of the photopolymer 204 may proceed.

FIG. 9 illustrates the optical film 200 after a seventh, eighth and ninth step of manufacture are completed. In the seventh step, the photomask 212 and index matching fluid 208 are removed. Then, in eighth step, the coating of photopolymer 204 is developed by applying a solvent that dissolves the unpolymerized photopolymer 218. The solvent used to develop the coating of photopolymer 204 may be IPA, EOH, MeOH, MEK, DCM, acetone or any other suitable material.

Then, in ninth step, a post UV exposure may be performed to make sure that all monomers of the plurality of structures 216 are fully cured. This post UV exposure has the further advantage of strengthening the plurality of structures 216.

FIG. 2 illustrates the completed optical film 200 after a tenth and eleventh step of manufacture are completed. In the tenth step, the gaps between each of the plurality of structures 216 is filled with an optically clear filler material 220 which has lower refractive index than the plurality of structures 216. The optically clear filler material 220 may be a UV curable material, a thermally curable material or any other suitable material. For example, the optically clear filler material 220 may be silicon that includes a catalyst, a photopolymer with a photoinitiator or any other suitable material or materials. Advantageously, the thickness of the optically clear filler material 220 above the plurality of structures 216 may be controlled in order to get the maximum reflection (e.g., total internal reflection) For example, this thickness may be selected to be greater than a quarter of a wavelength. Finally, in the eleventh step, the optically clear filler material 220 is cured.

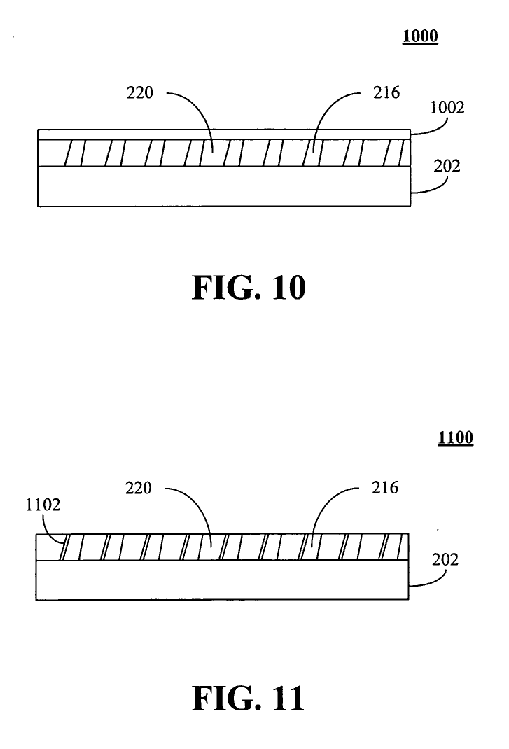

FIG. 10 illustrates another optical film 1000 which similar to that of FIG. 2 but further including a diffuser medium 1002. The diffuser medium 1002 is adjacent the plurality of structures 216 and the optically clear filler material 220 and may be a clear material in which light scattering particles, such as glass, silica or polymer beads, are dispersed in a certain amount, an embossed random surface relief diffuser or any other structure or material(s) that diffuses light. The diffuser medium 1002 provides additional light diffusion and provides additional control of the overall diffusivity of the optical film 1000.

FIG. 11 illustrates another optical film 1100 which similar to that of FIG. 2 but further including a reflective coating 1102 on one of the side wall surfaces of plurality of structures 216. The reflective coating 1102 may be included to enhance light reflection at any incident angle and made be made from a thin film of metal, a thin film of a dielectric material or any other suitable material or materials. For example, the reflective coating 1102 may be any metallic thin film such as a thin film of aluminum or silver, or a dielectric thin film.

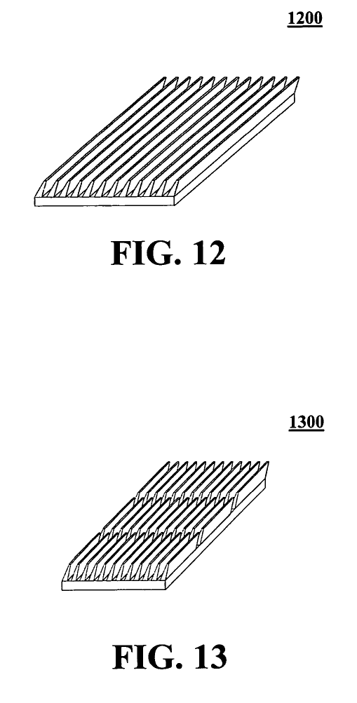

FIG. 12 illustrates an exemplary optical film 1200 with continuous structures 216 while FIG. 13 illustrates an exemplary optical film 1300 with segmented structures 216. The optical film 1200 with continuous structures 216 has improved optical performance while the optical film 1300 with segmented structures 216 has reduces shrinkage stress.

The optical film 200 includes three primary components: a main structure, a surrounding medium and a transport platform. The main structure acts as a light guiding pipes and light reflecting surfaces. This structure includes of plural light pipes which are tilted with a certain angle that is determined according to the light coming from the light source. The angles of these light pipes are determined during the exposure process. The side wall angles of the light pipes may be different because of the collimated actinic radiation. The side wall angles are defined by not only the exposure angle but also the refractive index difference between monomer used in this system and polymer formed during the exposure. The surrounding medium is located around the main structure and may be air or one or more materials which have lower refractive index that the cured polymer of the main structure which is formed by the curing process during the exposure and the post hard curing. The transporting platform carries materials during processing and supports the main structure and surrounding medium. The transporting platform may be a substrate or other suitable structure. For example, the transporting platform may be a film or sheet which is transparent to a wavelength range from 300 to 800 nm. In the photolithographic process illustrated in FIG. 2 through FIG. 9, the main structure corresponds to the plurality of structures 216, the surrounding medium corresponds to the optically clear filler material 220, and the transport platform corresponds to the substrate 202.

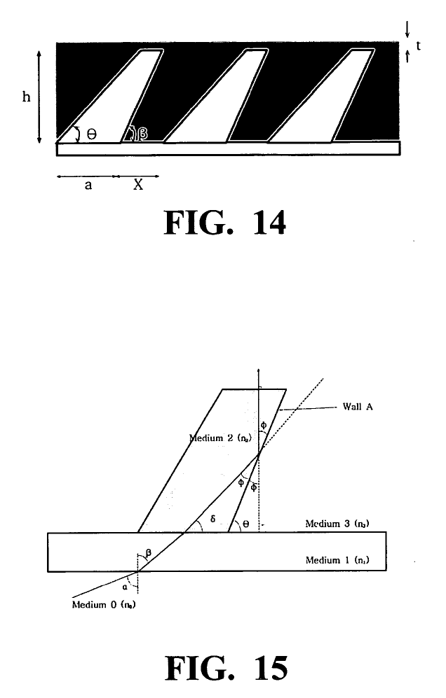

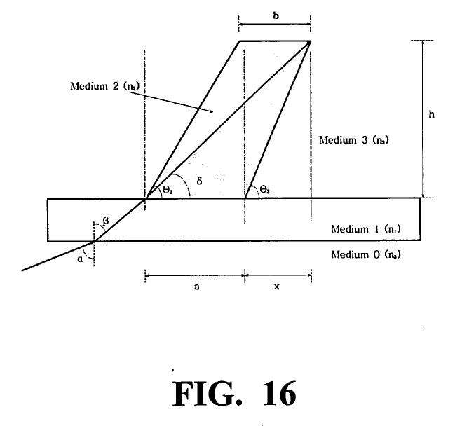

FIGS. 14, 15 and 16 illustrate various parameters of an optical film 200 including:

α=the original incident angle of light (incidence angle in Medium 0);

β=the incident angle of light after refraction at the Medium 0 and Medium 1 interface (incidence angle in Medium 1);

δ=the incident angle of light after refraction at the Medium 0 and Medium 1 interface and after refraction at the Medium 1 and Medium 2 interface but without having passed through Medium 3 (incidence angle in Medium 2)

Φ=the incident angle of light striking a sidewall of the structure;

θ₁=the acute angle formed by the sidewall of the structure and the base of the structure;

θ₂=180 degrees minus the obtuse angle by sidewall of the structure and the base of the structure;

a=the base dimension of the structure;

b=the top dimension of the structure;

x=the space between the base of one structure and the base of the adjacent structure;

t=the thickness of the surrounding medium above the structure;

h=the height of the structure;

δ=angle of light coming into the structure;

σ=critical angle for the total internal reflection; and

n₀, n₁, n₂, n₃=the refractive index of Medium 0, Medium 1, Medium 2, and Medium 3, respectively.

Assuming that the light is coming in to the structure with an angle δ and the light is desirable to have the light exit the structure at a normal angle (90 degrees), the angle of the structure θ₁ may be derived as follows.

Because δ+2φ=90 and sin

$$σ = \frac{{n}_{3}}{{n}_{2}} ,$$

thus
θ₁=(90+δ)/2. (Equation 1)
The angle δ can be determined by the angle a, which is the angle of the light coming from the light source, light guiding plate or other structure. In the most case, the light from light source, light guiding plate or other structure has the highest strength in the range of output angle between 10 and 20 degrees. In order to get the total internal reflection condition at the sidewall “A” and to redirect the light with a normal angle, the angle of the structures should be determined according to the incident angle.

The critical angle, σ for the total internal reflection may be derived from the Snell's law as follows:

$$\frac{{n}_{3}}{{n}_{2}} = \frac{sin σ}{sin 90} , thus σ = {sin}^{- 1} ( \frac{{n}_{3}}{{n}_{2}} )$$

If light goes through the transport platform (Medium 1) and the main structure (Medium 2) or surrounding medium (Medium 3), the light should hit at least one side wall of the main structure before escaping from the main structure or the surrounding medium, otherwise the light coming out from the top of the structures or the surrounding medium will have same angle as the original incident angle (α). In order to avoid this problem, the structure should be designed in the way of controlling the dimensions of “a”, “h” and θ₁ and θ₂. This may be achieved as follows.

The parameters θ₁ and θ₂ are defined by the exposure process, which may be obtained by exposing the system including the mask, substrate and the monomer mixture coated on the substrate. The parameter a and gap between the structures may be determined by the design of mask. The whole configuration may be designed according to the characteristics of light source or the light coming out from the light source, light guiding plate or other structure. The design rule including dimensions and the shape of the structure may be derived by the explanation described hereunder.

Assuming that the most of light is coming out with an angle α, and entering into the medium 1 (substrate) which has the refractive index of n₁. Then, by Snell's law

$$\frac{sin β}{sin α} = \frac{{n}_{0}}{{n}_{1}} ,$$

assuming that medium 0 is air then n₁ is 1.

$$\begin{matrix}Therefore , sin β = \frac{1}{{n}_{1}} sin α β = {sin}^{- 1} ( \frac{1}{n} sin α ) \\ \frac{sin ( 90 - δ )}{sin β} = \frac{{n}_{1}}{n 2} , sin ( 90 - δ ) = \frac{{n}_{1}}{{n}_{2}} sin β , \\ δ = 90 - \frac{{n}_{1}}{{n}_{2}} {sin}^{- 1} ( \frac{1}{{n}_{1}} sin α ) & ( Equation 2 ) \\ Hence , \frac{h}{a + x} = tan δ and \frac{h}{x} = tan {θ}_{2} , thus x = \frac{h}{tan {θ}_{2}} \\ And , h = tan δ ( a + x ) = tan δ ( a + \frac{h}{tan {θ}_{2}} ) & ( Equation 3 ) \\ Thus , h = \frac{a tan δ tan {θ}_{2}}{tan {θ}_{2} - tan δ} & ( Equation 4 )\end{matrix}$$

For an example, if a=30μ and a=80 degrees, δ will be about 53 degrees. Then θ₂ should be 71.87 degree. Therefore

$$h = \frac{30 \times ( 2.99 \times 1.33 )}{( 2.99 - 1.33 )} = 71.87 ( μm ) .$$

According to Equation 1, 2 and 3, θ should be 71.48 degrees in the case that α is 80 degrees in order to meet the condition mentioned previously. Additionally, if a is 70 degrees, θ should be 70.48 degrees approximately. If we consider that the light coming into the media with angles between 10 and 20 degrees and the refractive indices of the media are n₀=1, n₁=1.52, n₂=1.56 and n₃=1.43, the angle Φ should be around 18.5 which is less than the critical angle σ that is about 23.56 degrees in this case. Thus, most of the light may undergo total internal reflection.

Accordingly, the key parameters such as θ and h may be derived according to the initial conditions such as α (the original incident angle of the light) and a (base dimension of the structure). Although α can be predetermined by the configuration of the backlight system or from the light coming out of the light source, light guiding plate or other structure, a should be determined by considering the resolving power of the exposure system, amount of the material to be coated, the whole thickness of the optical film and the convenience of the process.

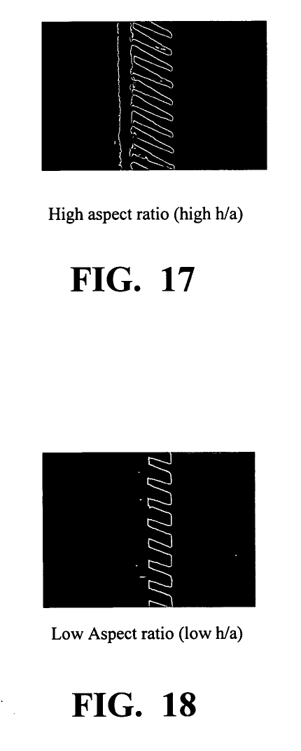

FIG. 17 is a black and while photograph of an optical film 200 with a high aspect ratio (h/a is large). FIG. 18 is a black and while photograph of an optical film 200 with a low aspect ratio (h/a is low).

The optical films disclosed herein may be used in a number of prior art backlights and other devices. For example, in FIG. 19 illustrates a prior art back-illuminator or backlight 1900 for a transmission type LCD. The backlight 1900 includes a light source 1902 such as a cold cathode fluorescent lamp or light emitting diodes, an aluminum coated reflecting sheet 1904, a light guiding plate 1908 with printed dots or molded grooves 1906 on the rear surface of the light guiding plate 1908, a diffuser 1910, a bottom prismatic sheet 1912, an upper prismatic sheet 1914, another diffuser 1916. An optical film as disclosed herein may be substituted for all the diffusers 1910, 1916 and prismatic sheets 1912, 1914 used in the backlight 1900 of FIG. 19 and similar substitutions may be made in other prior art devices. This substitution reduces the number of elements, reduces costs and improves performance.

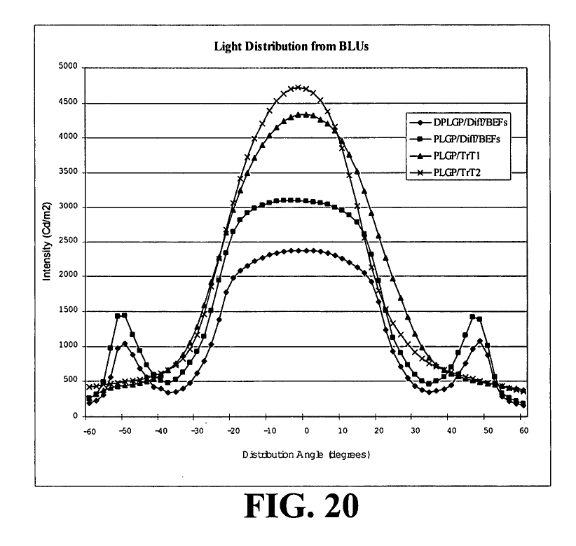

FIG. 20 illustrates the performance of four backlight units (BLUs) including a prior art dot printed light guiding plate/diffuser/brightness enhancement films combination (DPLGP/diff/BEF), a prior art prism light guiding plate/diffuser/brightness enhancement films combination (PLGP/diff/BEF), and two examples of the present invention used in BLUs. The examples utilizing the present invention include a prism light guiding plate in combination with an optical film according to the present invention (TrT). The performance of BLU with the optical films according to the present invention differs in the PLGP/TrT2 BLU was formed with a lower haze substrate than in the PLGP/TrT1 BLU. As is shown, the light intensity of the BLUs including an inventive optical film have greatly increased light intensity as compared with the comparative prior art BLUs.

Exemplary optical film formation:

A 002 MEL 454 PET substrate from Tekra of Orange, Calif. having a 2 mil thickness was blown with ionized air to clean the PET film. Alternatively, a tackey film may be used to clean the substrate. Next a mixture of SR349 monomer (about 95% by weight) from Startomer of Warrington, Pa. and IrgaCure 651 photoinitiator (about 5% by weight) from Ciba Specialty Chemical Corp. of Tarrytown, N.Y. were coated on the PET substrate to a thickness of about 5 mils. Next ultraviolet light from a metal arc lamp (=365 nm) having a collimation greater than 10° was used to illuminate Cr photomask at an angle of between 30° and 40° to selectively polymerize the SR349 monomer on the substrate. The metal arc lamp (25 watt/M²) was energized so as to give a 7-11 mJ/M² dose with about 10 mJ/M² dose being typical. Alternatively, better collimated light sources, such as UV laser, may be used. The unpolymerized monomer is then removed in an agitated solvent bath of either 99+% pure methanol or ethanol. The bath lasts about 15-25 seconds, which is about 30-45 strokes. The substrate and the polymerized monomer are dried by blowing off any remaining solvent. Finally a post cure is performed by energizing the metal arc lamp so as to provide a 500-3000 10 mJ/M² UV dose. This results in an optical film with a=−30 μm, b=−18-20 μm, x=−12 μm h=−65 μm, ₁=−63° and ₂=−71°.

The optical films disclosed herein may be used in conjunction with any conventional optical film. For example, they may be used with diffusers and brightness enhancing films.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. An optical film comprising:
a plurality of structures formed from a material with each structure including:
a base;
a first side wall that forms an acute angle with the base; and
a second side wall that forms an obtuse angle with the base.

2. The film of claim 1, further comprising a substrate having a top surface,
wherein the plurality of structures are on or adjacent the top surface.

3. The film of claim 1, wherein the acute angle is equal to about (90+δ)/2, where δ is the angle of light coming into the plurality of structures.

4. The film of claim 1, wherein h is equal to about a tan δ, tan θ/(tan θ−tan δ), where h is the height of the structures, a is the width of the base of each structure, δ is the angle of light coming into the plurality of structures, and θ is the acute angle.

5. The film of claim 1, wherein each structure includes a top such that the first side, the second side, the base and the top form a quadrilateral.

6. The film of claim 5, wherein each top is flat.

7. The film of claim 5, wherein each top is textured.

8. The film of claim 1, wherein the material is a photopolymerized material.

9. The film of claim 1,
wherein another material is between adjacent structures of the plurality of structures; and
wherein the another material has a lower refractive index than the material of the plurality of structures.

10. The film of claim 9, wherein the another material includes scattering particles.

11. The film of claim 9, wherein the another material is air.

12. The film of claim 9, further comprising a diffusing material that covers the another material and a surface of each structure opposite the base.

13. The film of claim 1, wherein each first side wall is coated with a reflective coating.

14. The film of claim 13, wherein the reflective coating is a metal coating.

15. The film of claim 13, wherein the reflective coating is a dielectric material coating.

16. The film of claim 1, wherein another material is between adjacent structures of the plurality of structures and covers a surface of each structure opposite the base.

17. An optical film comprising:
a substrate;
a plurality of structures on or adjacent the substrate and formed from a photopolymerized material with each structure including:
a base;
a first side wall that forms an acute angle with the base;
a second side wall that forms an obtuse angle with the base; and
a top, the top being substantially parallel to the base, forming an acute angle with the second side wall, and forming an obtuse angle with the first side wall; and
another material having a lower refractive index than the material of the plurality of quadrilateral structures, the another material being located between adjacent first and second side walls.

18. The film of claim 17, wherein the another material covers the tops of the plurality of structures.

19. A method of making an optical film comprising:
depositing a photopolymerizable material on a surface;
selectively polymerizing part of the photopolymerizable material such that a plurality of polymerized structures is formed in the photopolymerizable material, each polymerized structure having:
a first side wall that forms an acute angle with the surface; and
a second side wall that forms an obtuse angle with the surface; and
removing the photopolymerizable material not polymerized.

20. The method of claim 19, wherein the selectively polymerizing is performed by illuminating a photomask with collimated light that is incident on the surface at a non-normal angle.

21. The method of claim 19, further comprising depositing an optically clear filler material between the plurality of polymerized structures subsequent to the step of removing the photopolymerizable material not polymerized.

22. An optical film for use in a light source comprising:
a substrate; and
a plurality of structures formed from a photopolymerized material with each structure including:
a base;
a first side wall that forms an acute angle with the base; and
a second side wall that forms an obtuse angle with the base,
wherein h is equal to about a tan δ tan θ (tan θ−tan δ), where h is a height of the structures, a is a width of the base of each structure, δ is an angle of light coming into the
plurality of structures from a light source, and θ is the acute angle.
